(19) United States
(12) Patent Application Publication
(10) Pub. No.: US 2014/0062450 A1
(43) Pub. Date: Mar. 6, 2014

(54) CAPACITIVE LOAD DRIVE CIRCUIT, LIQUID EJECTION PRINTING APPARATUS, LIQUID EJECTION DEVICE, FLUID TRANSPORTATION DEVICE, AND MEDICAL INSTRUMENT

(71) Applicant: SEIKO EPSON CORPORATION, Tokyo (JP)

(72) Inventor: Atsushi OSHIMA, Kanie-machi (JP)

(73) Assignee: SEIKO EPSON CORPORATION, Tokyo (JP)

(21) Appl. No.: 14/017,038

(22) Filed: Sep. 3, 2013

(30) Foreign Application Priority Data
Sep. 3, 2012 (JP) 2012-193274

(51) Int. Cl. H02M 3/158

(52) U.S. Cl. CPC H02M 3/158
USPC 323/311

(57) ABSTRACT

A capacitive load drive circuit includes a modulation circuit adapted to pulse-modulate a drive waveform signal to thereby generate a modulation signal, two switching elements (transistors) constituting a push-pull circuit and adapted to generate a power-amplified modulation signal, a low-side driver and a high-side driver adapted to switch ON/OFF of the respective switching elements, a bootstrap circuit, a power supply adapted to supply the low-side driver and the high-side driver with a predetermined electrical potential, and a first resistor disposed in a supply channel from the power supply to the bootstrap circuit.

### BACKGROUND

1. Technical Field

The present invention relates to a technology for applying a drive signal to a capacitive load such as a piezoelectric element to thereby drive the capacitive load.

2. Related Art

There are many actuators, which are each formed of a capacitive load such as a piezoelectric element, such as an ejection head installed in an inkjet printer. In order to drive such an actuator as a capacitive load, a drive signal having a certain level of electrical power is required. Therefore, there is performed generation of the drive signal by power-amplifying a drive waveform signal, which is a base of the drive signal. Here, in the case of power-amplifying the analog drive waveform signal in an analog manner to directly generate the analog drive signal, a significant power loss occurs to degrade the power efficiency. Therefore, there has been proposed a technology of performing the power amplification using a so-called class-D amplifier.

The class-D amplifier performs the power amplification in the following manner. Firstly, a modulation signal is generated by pulse-modulating the analog drive waveform signal. Although there are known several methods of the pulse modulation, it is common to use a method called pulse width modulation (PWM). In the pulse width modulation, the drive waveform signal to be modulated is compared to a triangular waveform repeated at a regular period, and an ON level is output in the period in which the voltage of the drive waveform signal is higher than the voltage of the triangular waveform, and an OFF level is output, by contrast, in the period in which the voltage of the drive waveform signal is lower to thereby generate the modulation signal repeating the ON level and the OFF level. The higher the voltage of the drive waveform signal becomes, the higher the proportion of the ON period in one modulation cycle, namely the duty ratio, of the modulation signal obtained in such a manner becomes.

In the class-D amplifier, the digital modulation signal obtained by the pulse modulation is power-amplified, and then converted into an analog signal through a smoothing filter to thereby generate the power-amplified drive signal. By power-amplifying the digital modulation signal in such a manner, the power loss can dramatically be reduced compared to the case of power-amplifying the analog drive waveform signal while keeping the analog state, and therefore, it is possible to dramatically reduce the power loss in generating the drive signal. For example, the invention disclosed in JP-A-2005-329710 (Document 1) also uses the class-D amplifier circuit, and is thus capable of reducing the power loss.

Here, the invention disclosed in Document 1 includes a bootstrap circuit composed of a diode D0 and a capacitor C0. Further, in the class-D amplifier circuit, a low-pass filter (LPF) for restoring the original analog drive signal after the power amplification is disposed to demodulate the analog drive signal. The LPF is composed of, for example, a coil and a capacitor, and drives an actuator formed of a capacitive load. Therefore, the electrical potential of a signal input section of the LPF before a gate driver starts an operation is the same as a high potential supplied to the gate driver. In other words, it is not the case that the electrical potential has become the ground potential before the gate driver starts the operation as in the case of driving a resistive load.

Then, when the gate driver starts the operation, a current rapidly flows through a switching element (e.g., the transistor Q25 shown in FIG. 2 in Document 1) on the grounded side (hereinafter referred to as a low side). Then, when the electric potential of the input section of the LPF is set to the ground potential, a rapid current flows through the diode D0 in order to charge the capacitor C0 of the bootstrap circuit. On this occasion, if a current exceeding the rated value flows, the transistor Q25 on the low side and the diode D0 might be deteriorated.

### SUMMARY

An advantage of some aspects of the invention is to provide a capacitive load drive circuit, a liquid ejection printing apparatus, a liquid ejection device, a fluid transportation device, and a medical instrument each preventing an excessive current from flowing through the bootstrap diode and the switching element on the low side to thereby have high reliability.

(1) An aspect of the invention is directed to a capacitive load drive circuit adapted to apply a drive signal to a capacitive load having a capacitive component to thereby drive the capacitive load, including a drive waveform signal generation circuit adapted to generate a drive waveform signal to be a basis of the drive signal, a modulation circuit adapted to pulse-modulate a drive waveform signal to thereby generate a modulation signal, two switching elements constituting a push-pull circuit, and adapted to generate a power-amplified modulation signal, which is a signal obtained by power-amplifying the modulation signal, a first gate driver adapted to switch ON/OFF of a first switching element, which is one of the two switching elements disposed on a ground potential side, based on the modulation signal, a second gate driver adapted to switch ON/OFF of a second switching element, which is the other of the two switching elements, based on the modulation signal, a bootstrap circuit having a first capacitor electrically connected to a first node, which is a contact point to which the two switching elements are connected, a power supply adapted to supply the first gate driver and the second gate driver with a predetermined electrical potential, a first resistor disposed in a supply channel from the power supply to the bootstrap circuit, and a smoothing filter adapted to smooth the power-amplified modulation signal to thereby generate the drive signal.

The capacitive load drive circuit according to this aspect of the invention pulse-modulates the drive waveform signal to be the basis of the drive signal to be applied to the capacitive load to thereby generate the modulation signal, and then power-amplifies and then smoothes the modulation signal thus obtained to thereby generate the drive signal.

In the capacitive load drive circuit according to this aspect of the invention, the modulation signal is power-amplified by the two switching elements connected to each other so as to form a push-pull structure. The two switching elements include a first switching element as a low-side switching element, and a second switching element as a high-side (a high electrical potential side) switching element.

Further, the capacitive load drive circuit according to this aspect of the invention includes the first gate driver and the second gate driver adapted to switch ON/OFF of the first switching element and the second switching element, respectively. The first date driver generates a gate signal, which can take the ground potential and a predetermined potential derived from the power supply. The capacitive load drive circuit according to this aspect of the invention is configured including the bootstrap circuit so that the second gate driver can also generate the gate signal having the same potential difference as that of the first gate driver.

Here, in the capacitive load drive circuit according to this aspect of the invention, the potentials of the wiring lines through which the power-amplified modulation signal and the drive signal are propagated become equal to a predetermined potential (a potential other than the ground potential) supplied from the power supply to the first gate driver and the second gate driver before the first gate driver and the second gate driver operate and in a stand-by period in which the operation is stopped. Specifically, in the case in which the first switching element and the second switching element are in the OFF state, a direct current does not flow because the load to be driven is a capacitive load, and the potentials of the wiring lines through which the power-amplified modulation signal and the drive signal are propagated become equal to the predetermined potential due to the leakage current from the second gate driver.

A contact point (a node) to which the first switching element and the second switching element are connected is defined as a first node. The first node is located on a wiring line through which the power-amplified modulation signal is propagated. One end of the bootstrap capacitor, which is the first capacitor constituting the bootstrap circuit, is connected to the first node. Since the potential of the first node is equal to a predetermined potential before the first gate driver and the second gate driver operate, and in the stand-by state and so on, the inter-terminal voltage of the bootstrap capacitor is kept at roughly zero.

When the low-side switching element (the first switching element) turns ON after the first gate driver and the second gate driver are made to start in the state described above, a current rapidly flows through the first switching element, and thus the potential of the first node changes from the predetermined potential to the ground potential. Then, in order to charge the bootstrap capacitor, a current flows through a channel from the power supply to the ground potential (hereinafter also described as GND) passing through the bootstrap diode as a diode constituting the bootstrap circuit, the bootstrap capacitor, and the first switching element.

Here, in the case in which a component for limiting the current is not at all disposed in the supply channel from the power supply to the bootstrap circuit, it is possible that, for example, the current as high as about 10 A flows rapidly. On this occasion, due to the flow of the current higher than the rated value, the bootstrap diode and the first switching element might be deteriorated.

However, the capacitive load drive circuit according to this aspect of the invention has the first resistor disposed in the supply channel from the power supply to the bootstrap circuit. For example, assuming that the resistance value of the first resistor is on the order of 10Ω, even in the case in which the current as high as on the order of 10 A has been flowing, the current can be suppressed to on the order of 1 A. Specifically, the capacitive load drive circuit according to this aspect of the invention prevents the overcurrent from flowing through the bootstrap diode and the low-side switching element when the gate driver starts the operation. Therefore, it is possible to prevent the deterioration of these components to thereby provide the capacitive load drive circuit high in reliability.

(2) The capacitive load drive circuit described above may be configured such that the bootstrap circuit includes a diode electrically connected to the first capacitor, and the first resistor is disposed between a second node, which is a contact point to which the diode and the second gate driver are connected, and the power supply.

According to this aspect of the invention, the first resistor for limiting the current flowing through the bootstrap diode and the low-side switching element is disposed between the second node and the power supply. The second node is a contact point to which the bootstrap diode and the second gate driver are connected. On this occasion, even in the case of disposing the bootstrap diode, the gate signal from the gate driver is never blunted.

It should be noted that the first resistor can be disposed on the anode side of the bootstrap diode, or can be disposed on the cathode side.

(3) The capacitive load drive circuit described above may be configured such that the bootstrap circuit includes a diode electrically connected to the power supply, and the first resistor is disposed between a second node, which is a contact point to which the diode and the second gate driver are connected, and the first capacitor.

(4) The capacitive load drive circuit described above may be configured such that the capacitive load drive circuit further includes a second capacitor disposed between a third node, which is a contact point to which the power supply and the first gate driver are connected, and the ground potential, and a second resistor disposed between the third node and the second capacitor.

(5) The capacitive load drive circuit described above may be configured such that a resistance value of the first resistor and a resistance value of the second resistor are equal to each other.

According to these aspects of the invention, the first resistor for limiting the current flowing through the bootstrap diode and the low-side switching element is disposed between the second node and the bootstrap capacitor. On this occasion, by disposing the first resistor, it results that the gate signal from the second gate driver is blunted. However, it is possible to avoid the short circuit caused by the two switching elements staying in the ON state at the same time using the delay in timing at which the second switching element turns to the ON state, the delay being caused by the blunting of the gate signal.

On this occasion, the second resistor can be disposed between the third node and the second capacitor. The second capacitor is connected between the contact point (the third node), to which the power supply and the first gate driver are connected, and the ground potential. On this occasion, by disposing the second resistor, it results that the gate signal from the first gate driver is blunted. Therefore, it is possible to easily create the dead time in which the two switching elements are in the OFF state at the same time by delaying the timing at which the first switching element turns to the ON state.

The second resistor can have the same resistance value as that of the first resistor. On this occasion, the delay of the timing at which the second switching element turns to the ON state and the delay of the timing at which the first switching element turns to the ON state are equal to each other. Therefore, the dead time can more easily be provided.

(6) Another aspect of the invention is directed to a liquid ejection printing apparatus including the capacitive load drive circuit according to any one of the aspects of the invention described above.

(7) Still another aspect of the invention is directed to a liquid ejection device including the capacitive load drive circuit according to any one of the aspects of the invention described above.

(8) Yet another aspect of the invention is directed to a fluid transportation device including the capacitive load drive circuit according to any one of the aspects of the invention described above.

(9) Still yet another aspect of the invention is directed to a medical instrument including the capacitive load drive circuit according to any one of the aspects of the invention described above.

The liquid ejection printing apparatus, the liquid ejection device, the fluid transportation device, and the medical instrument according to these aspects of the invention include the capacitive load drive circuit, which prevents the overcurrent from flowing through the bootstrap diode, and the low-side switching element, and is therefore high in reliability. Therefore, it is possible to enhance the reliability as the liquid ejection printing apparatus, the liquid ejection device, the fluid transportation device, and the medical instrument.

The liquid ejection printing apparatus is, for example, an inkjet printer. By forming minute ink dots on a print medium by discharging (ejecting) liquid ink droplets from nozzles of a print head (also referred to as an inkjet head) while reciprocating a movable body called a carriage integrally provided with an ink cartridge and the print head on the print medium in a direction intersecting with the feeding direction of the print medium, predetermined characters and images are drawn on the print medium to thereby create a desired printed material. The capacitive load drive circuit provides the drive signal to, for example, the piezoelectric element of the ejection head.

The liquid ejection device is known as, for example, a medical instrument. A surgical instrument, which supplies a liquid at a high pressure from the pump to a tube introduced in the body cavity, and ejects the liquid from the nozzle on the tip of the tube to perform excision of intracavitary tissue using the fluid pressure, is also an example of the liquid ejection device. Further, a device, which rapidly changes the volume of the fluid chamber with a volume changing device to convert the fluid into a pulsating flow, and then ejects the fluid from the nozzle at a high speed in a pulsed manner, and thus performing excision and incision of body tissue using the impact pressure, is also an example of the liquid ejection device. The capacitive load drive circuit provides the drive signal to, for example, the piezoelectric element of the pulsating flow generation section.

The fluid transportation device is a device for transporting a liquid at a stable flow rate such as a medication pump, and can also be provided with an extrusion mechanism for sequentially pressing a plurality of pressing shafts from the inflow side of the fluid toward the outflow side. The capacitive load drive circuit provides the drive signal to, for example, the piezoelectric element of the extrusion mechanism. It should be noted that by transporting the liquid at a stable flow rate and then dropping the liquid, the capacitive load drive circuit can also be applied to, for example, an infusion device. In other words, the capacitive load drive circuit can be applied not only to the liquid ejection device and the fluid transportation device described above, but also to a variety of medical instruments.

### BRIEF DESCRIPTION OF THE DRAWINGS

The invention will be described with reference to the accompanying drawings, wherein like numbers reference like elements.

FIG. 1 is an explanatory diagram exemplifying an inkjet printer equipped with a capacitive load drive circuit according to a first embodiment of the invention.

FIG. 2 is an explanatory diagram showing the state in which the capacitive load drive circuit according to the first embodiment drives an ejection head.

FIG. 3 is an explanatory diagram showing a detailed configuration of the capacitive load drive circuit according to the first embodiment.

FIG. 4 is an explanatory diagram showing an outline of an operation of the capacitive load drive circuit according to the first embodiment generating a drive signal.

FIG. 5 is a diagram showing a configuration of a capacitive load drive circuit of a comparative example.

FIG. 6 is a diagram for explaining a problem of the capacitive load drive circuit of the comparative example.

FIG. 7 is an explanatory diagram showing a detailed configuration of a capacitive load drive circuit according to a second embodiment of the invention.

FIG. 8 is a diagram showing an example of a waveform of a gate signal.

FIG. 9 is a diagram showing an example of an improved waveform of the gate signal.

FIG. 10 is a diagram for explaining a channel of a current in charging the gate according to a method of the related art.

FIG. 11 is a diagram for explaining a channel of a current in discharging the gate according to a method of the related art.

FIG. 12 is a diagram for explaining a channel of a current in charging the gate of the capacitive load drive circuit according to the second embodiment.

FIG. 13 is a diagram for explaining a channel of a current in discharging the gate of the capacitive load drive circuit according to the second embodiment.

FIG. 14 is an explanatory diagram exemplifying a fluid ejection device according to an application example.

FIG. 15 is a cross-sectional view showing a cutting surface along the ejection direction of the fluid with respect to a pulsating flow generation section of the fluid ejection device according to the application example.

FIG. 16 is an explanatory diagram exemplifying an appearance of fluid transportation equipment including a fluid transportation device according to another application example.

FIG. 17 is a diagram for explaining a mechanism of the fluid transportation of the fluid transportation device.

### DESCRIPTION OF EXEMPLARY EMBODIMENTS

Hereinafter, some embodiments of the invention will be explained along the following procedure in order to clarify the content of the invention described above.

A. First Embodiment
A-1. Device Configuration
A-2. Circuit configuration of Capacitive Load Drive Circuit
A-3. Operation of Capacitive Load Drive Circuit

B. Second Embodiment

C. Application Example

D. Others

### A. First Embodiment

### A-1. Device Configuration

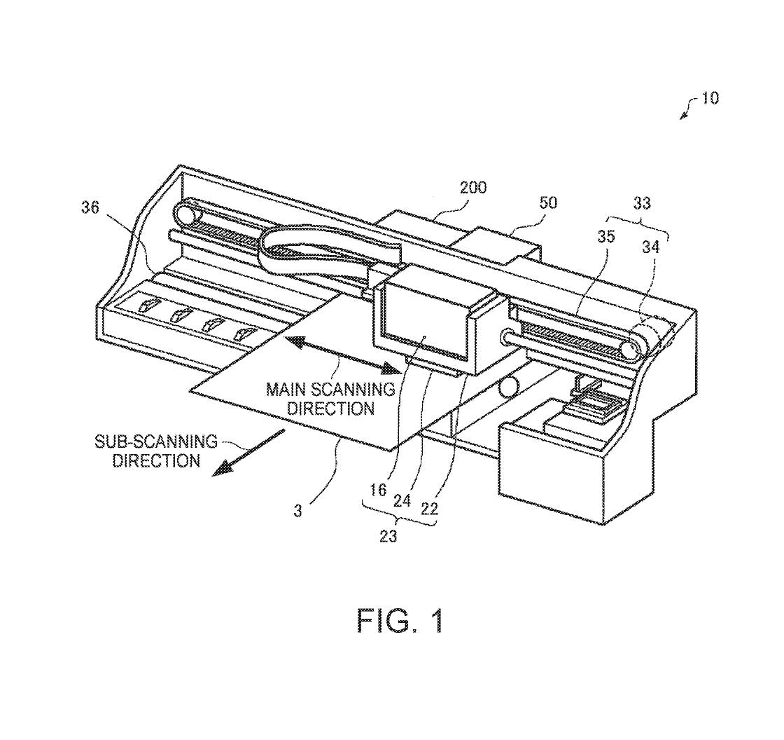

FIG. 1 is an explanatory diagram exemplifying an inkjet printer 10 equipped with a capacitive load drive circuit 200 according to the present embodiment. The inkjet printer 10 shown in the drawings is composed of a carriage 23 for forming ink dots on a print medium 3 while reciprocating in a main scanning direction, a drive mechanism 33 for reciprocating the carriage 23, a platen roller 36 for performing paper feeding of the print medium 3, and so on. The carriage 23 is provided with an ink cartridge 16 housing ink, a carriage case 22 attached with the ink cartridge 16, an ejection head 24 mounted on a bottom surface side (the side facing to the print medium 3) of the carriage case 22 and for ejecting the ink, and so on, and by guiding the ink in the ink cartridge 16 to the ejection head 24, and then ejecting the ink from the ejection head 24 to the print medium 3, an image is printed.

The drive mechanism 33 for reciprocating the carriage 23 is composed of a timing belt 35 stretched by pulleys, a stepping motor 34 for driving the timing belt 35 via the pulleys, and so on. A part of the timing belt 35 is fixed to the carriage case 22, and by driving the timing belt 35, it is possible to reciprocate the carriage case 22. Further, the platen roller 36 constitutes a paper feed mechanism for performing the paper feed of the print medium 3 together with a drive motor and a gear mechanism not shown, and is arranged to be capable of performing the paper feed of the print medium 3 in the sub-scanning direction by a predetermined amount.

The inkjet printer 10 is also equipped with a printer control circuit 50 for controlling the overall operation, and the capacitive load drive circuit 200 for driving the ejection head 24. The printer control circuit 50 controls the overall operation of the capacitive load drive circuit 200, the drive mechanism 33, the paper feed mechanism and so on driving the ejection head 24 to eject the ink while performing the paper feed of the print medium 3.

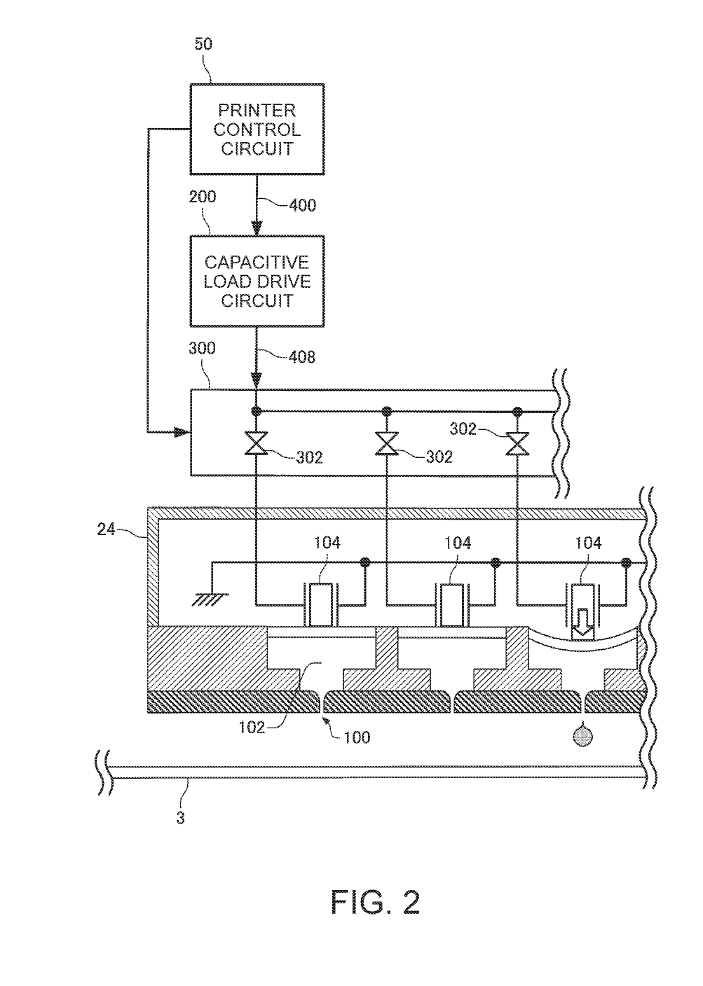

FIG. 2 is an explanatory diagram showing the state in which the capacitive load drive circuit 200 drives the ejection head 24 under the control by the printer control circuit 50. First of all, an internal structure of the ejection head 24 will briefly be explained. As shown in the drawing, a bottom surface of the ejection head 24 facing to the print medium 3 is provided with a plurality of ejection nozzles 100 for ejecting ink droplets. The ejection nozzles 100 are connected to respective ink chambers 102, and the ink chambers 102 are filled with the ink supplied from the ink cartridge 16. Above the ink chambers 102, there are disposed piezoelectric elements 104, respectively. When applying a voltage to the piezoelectric element 104, the piezoelectric element 104 deforms to pressurize the ink chamber 102 to thereby eject the ink from the ejection nozzle 100. Further, the piezoelectric element 104 changes in variation amount in accordance with the voltage value applied to the piezoelectric element 104. By applying an appropriate voltage waveform to the piezoelectric element 104 to thereby control the amount and the timing of the variation of the ink chamber 102, it is possible to eject an appropriate amount of ink at an appropriate timing.

A drive signal 408, which is the voltage to be applied to the piezoelectric element 104, is generated by the capacitive load drive circuit 200 based on a control signal 400 from the printer control circuit 50. Further, the drive signal 408 thus generated is supplied to the piezoelectric element 104 via a gate unit 300. The gate unit 300 is a circuit unit having a plurality of gate elements 302 connected in parallel to each other, and each of the gate elements 302 can individually be set to one of a conduction state and a disconnection state under the control by the printer control circuit 50. Therefore, the drive signal 408 output from the capacitive load drive circuit 200 passes through only the gate elements 302 previously set to the conduction state by the printer control circuit 50, and is then applied to the piezoelectric elements 104 corresponding to the gate elements 302 thus set, and the ink is ejected from the corresponding nozzles 100.

### A-2. Circuit Configuration of Capacitive Load Drive Circuit

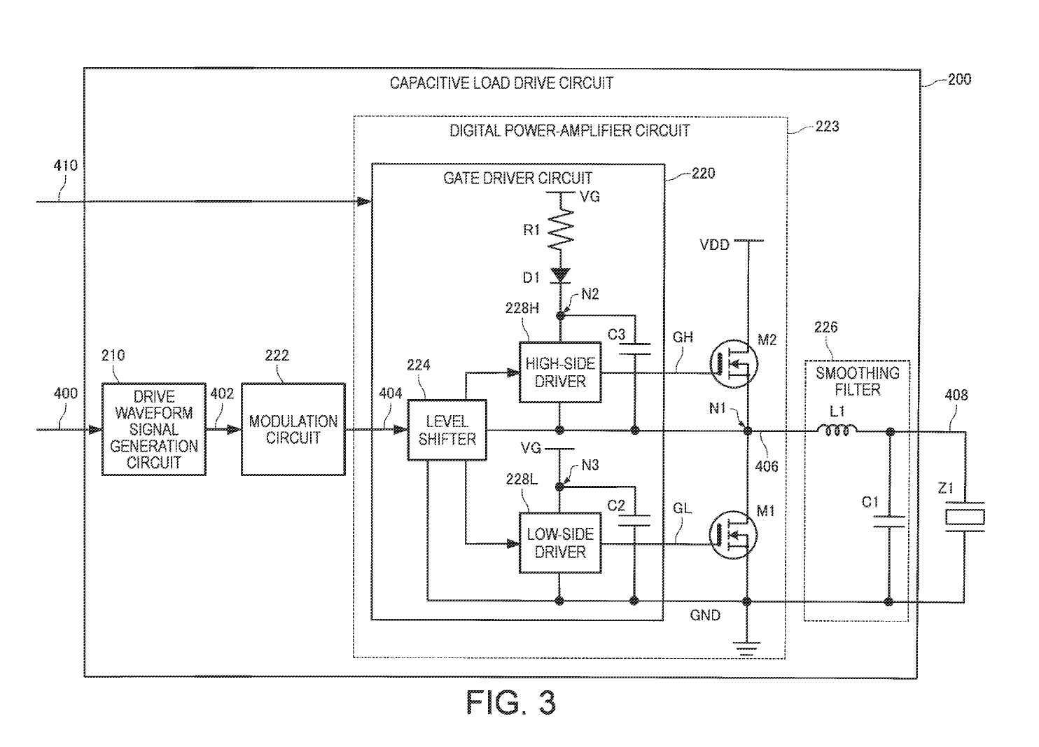

FIG. 3 is an explanatory diagram showing a detailed configuration of the capacitive load drive circuit 200 according to the present embodiment. As shown in the drawing, the capacitive load drive circuit 200 is configured including a drive waveform signal generation circuit 210 for generating a drive waveform signal 402 to be a basis of the drive signal 408 based on the control signal 400, a modulation circuit 222 for pulse-modulating the drive waveform signal 402 to thereby generate a modulation signal 404, a digital power amplifier circuit 223 for amplifying the modulation signal 404 to thereby generate a power-amplified modulation signal 406, and a smoothing filter 226 for removing a high frequency component of the power-amplified modulation signal 406 to thereby generate the drive signal 408.

The digital power amplifier circuit 223 includes a gate driver circuit 220 and two switching elements constituting a push-pull circuit and generating the power-amplified modulation signal 406. Although in the capacitive load drive circuit 200 according to the present embodiment, the two switching elements are N-type MOSFET (transistor M1, transistor M2), it is also possible to use other types of elements such as insulated gate bipolar transistors (IGBT).

As shown in FIG. 3, the transistor M1 and the transistor M2 are connected to each other between an electrical potential VDD (hereinafter simply referred to as VDD) supplied from the power supply and the ground potential GND (hereinafter simply referred to as GND) so as to form a push-pull structure. Further, by switching ON/OFF of the transistor M1 and the transistor M2, the power-amplified modulation signal 406 is generated. It should be noted that a contact point (a node) at which the transistor M1 and the transistor M2 are connected to each other is defined as a first node N1. The first node is located on a wiring line through which the power-amplified modulation signal 406 is propagated. Further, the transistor M1 connected to GND corresponds to a first switching element according to the invention, and the transistor M2 connected to VDD corresponds to a second switching element according to the invention.

The gate driver circuit 220 includes a level shifter 224 for regulating the level of the modulation signal 404, a low-side driver 228L (corresponding to a first gate driver according to the invention) for switching ON/OFF of the transistor M1 based on the modulation signal 404 having passed through the level shifter 224, a high-side driver 228H (corresponding to a second gate driver according to the invention) for switching ON/OFF of the transistor M2 based on the modulation signal 404 having passed through the level shifter 224, and a bootstrap circuit.

The bootstrap circuit is configured including a bootstrap diode D1 and a bootstrap capacitor C3, and one end of the bootstrap capacitor C3 is electrically connected to the first node N1. Here, the low-side driver 228L is directly connected to the power supply (corresponding to a power supply according to the invention, and hereinafter referred to as a power supply VG) having an electrical potential of VG. On the other hand, the high-side driver 228H is connected to the power supply VG via the bootstrap diode D1 and a first resistor R1. In detail, assuming that a contact point, at which the bootstrap capacitor C3 and the high-side driver 228H are connected to each other, is a second node N2, the bootstrap diode D1 and the first resistor R1 which are connected in series to each other are disposed between the second node N2 and the power supply VG. Here, the first resistor R1 can be disposed on the anode side of the bootstrap diode D1 as shown in FIG. 3, or can be disposed on the cathode side.

It should be noted that a contact point at which a capacitor C2 and the low-side driver 228L are connected to each other is defined as a third node N3. Further, a signal output from the low-side driver 228L for switching ON/OFF of the transistor M1 is defined as agate signal GL, and a signal output from the high-side driver 228H for switching ON/OFF of the transistor M2 is defined as a gate signal GH.

It should be noted that an enable signal 410 is a signal for switching between activation and inactivation of the gate driver circuit 220, and is output from the printer control circuit 50 in the present embodiment. Further, a capacitive load Z1 to which the drive signal 408 is applied corresponds to a piezoelectric element 104 shown in FIG. 2.

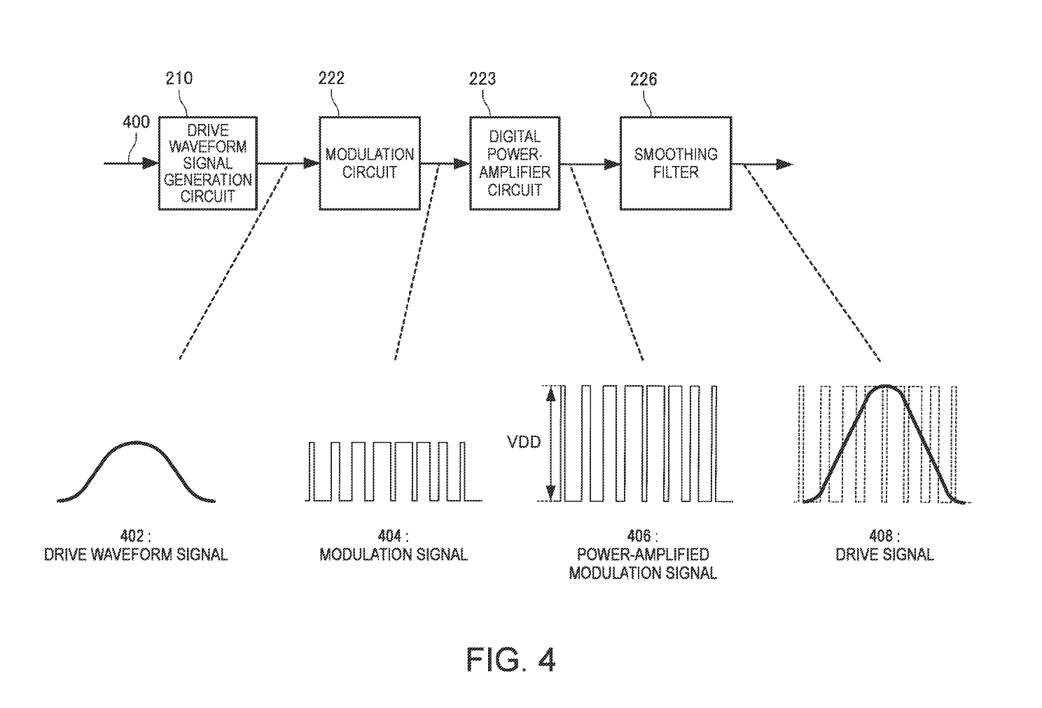

FIG. 4 is an explanatory diagram showing an outline of an operation of the capacitive load drive circuit 200 generating the drive signal 408. The drive waveform signal generation circuit 210 generates such a drive waveform signal 402 as shown in FIG. 4 based on the control signal 400. It should be noted that the drive waveform signal 402 is not limited to such an analog signal, but can be, for example, a signal output in a DC level.

The drive waveform signal generation circuit 210 can also be provided with, for example, a calculator, and can generate the drive waveform signal 402 by calculation based on the control signal 400. Further, the drive waveform signal generation circuit 210 can also be provided with, for example, a waveform memory for storing the waveforms, and can also generate the drive waveform signal 402 corresponding to the control signal 400 referring to the waveform memory.

When receiving the drive waveform signal 402 from the drive waveform signal generation circuit 210, the modulation circuit 222 performs predetermined modulation to generate the modulation signal 404. The predetermined modulation is the pulse-width modulation (PWM) in the present embodiment. However, other modulation methods such as pulse-density modulation (PDM) can also be used.

The modulation circuit 222 compares the drive waveform signal 402 with a triangular waveform repeated at a regular period, and outputs an ON level in the period in which the voltage of the drive waveform signal 402 is higher than the voltage of the triangular waveform, or an OFF level, by contrast, in the period in which the voltage of the drive waveform signal 402 is lower to thereby generate the modulation signal 404 repeating the ON level and the OFF level. The higher the voltage of the drive waveform signal 402 is, the higher the duty ratio of the modulation signal 404 obtained in such a manner is as shown in, for example, FIG. 4.

The digital power amplifier circuit 223 receives the modulation signal 404, and then performs the power amplification. As shown in FIG. 3, the digital power-amplifier circuit 223 amplifies the power using the transistor M1, the transistor M2, the gate driver circuit, and so on connected to each other so as to form a push-pull structure. In the example shown in FIG. 4, the digital power-amplifier circuit 223 generates the power-amplified modulation signal 406 obtained by amplifying the voltage of the modulation signal 404 to VDD.

Then, the smoothing filter 226 smoothes the power-amplified modulation signal 406 to thereby generate the drive signal 408, which is an analog signal high in voltage value in the part modulated to have a large pulse width and low in voltage value in the part modulated to have a narrow pulse width. As shown in FIG. 3, the smoothing filter 226 can easily be realized by combining the coil L1 and the capacitor C1 with each other.

In the capacitive load drive circuit 200 according to the present embodiment, since the power is amplified by switching ON/OFF of the switching elements (the transistor M1, the transistor M2) in the digital power-amplifier circuit 223, unnecessary power consumption is eliminated. Further, the smoothing filter 226 can also be formed of a component not consuming the power such as the coil L1 and the capacitor C1. Therefore, the power loss can dramatically be reduced compared to the case of power-amplifying the analog drive waveform signal 402 while keeping the analog state, and therefore, it is possible to dramatically reduce the power loss in generating the drive signal 408.

### A-3. Operation of Capacitive Load Drive Circuit

The configuration of the capacitive load drive circuit 200 according to the present embodiment is as explained with reference to FIG. 3, and the electrical potential difference between the high level and the low level of the gate signal GL from the low-side driver 228L is VG. Further, the capacitive load drive circuit 200 according to the present embodiment is configured including the bootstrap circuit having the bootstrap diode D1 and the bootstrap capacitor C3 so that the gate signal GH from the high-side driver 228H also has the same electrical potential difference (i.e., VG) as that of the gate signal GL.

Further, the capacitive load drive circuit 200 according to the present embodiment includes the first resistor R1 connected in series to the bootstrap diode D1. Here, in order to explain the function of the first resistor R1 of the capacitive load drive circuit 200, a capacitive load drive circuit 1200 of a comparative example will first be described.

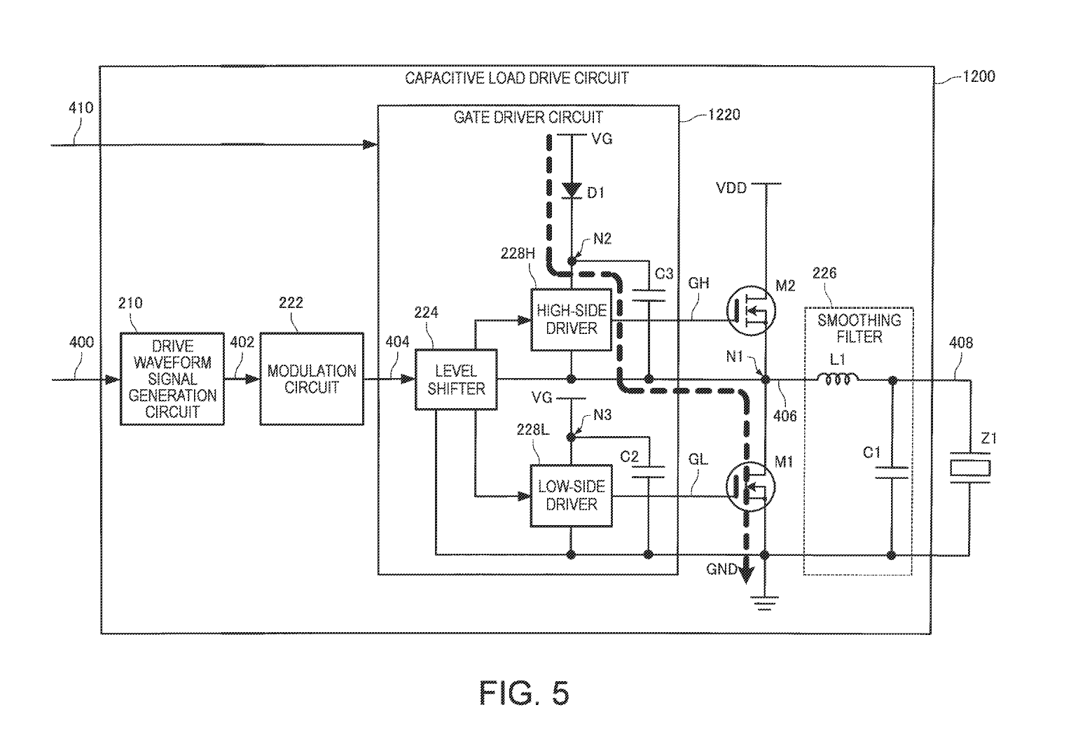

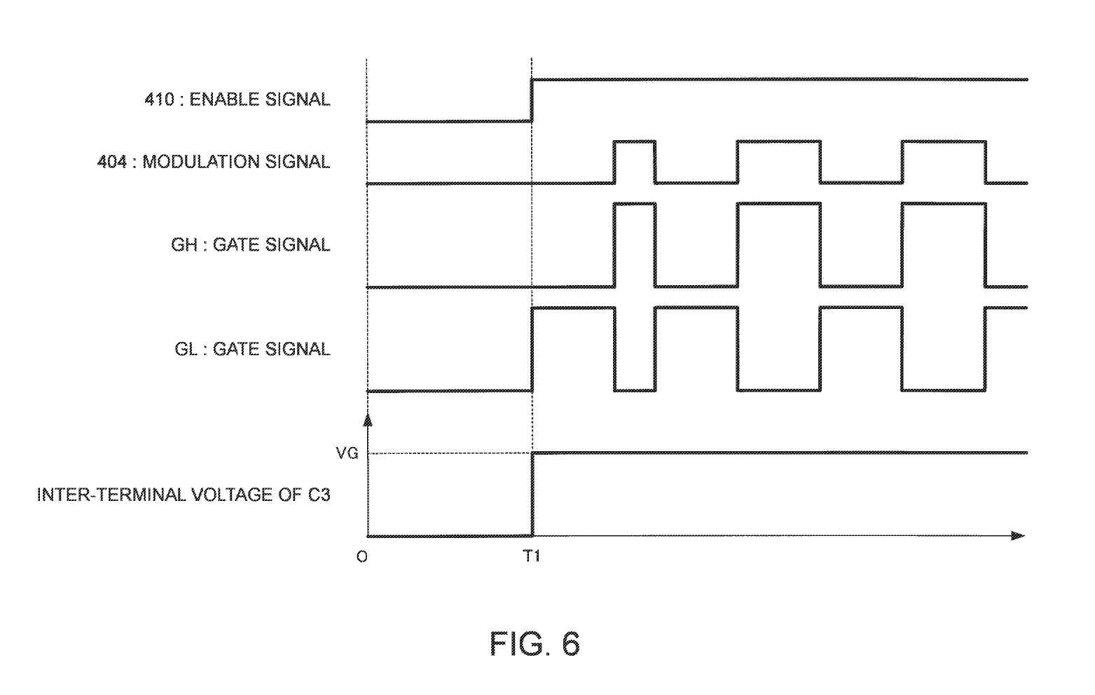

FIG. 5 is a diagram showing a configuration of the capacitive load drive circuit 1200 of the comparative example. Further, FIG. 6 is a waveform chart showing some signals of the capacitive load drive circuit 1200 shown in FIG. 5. It should be noted that the same components as those shown in FIGS. 1 through 4 are denoted with the same reference symbols, and the detailed explanation thereof will be omitted. For example, the signals and the bootstrap capacitor C3 shown in FIG. 6 are common to the components with the same reference symbols of the capacitive load drive circuit 200 according to the present embodiment.

Unlike the capacitive load drive circuit 200 according to the present embodiment, the capacitive load drive circuit 1200 of the comparative example does not include the first resistor R1 in the gate driver circuit 1220. Here, the capacitive load drive circuit 1200 also drives the capacitive load Z1. Therefore, the electrical potential of the first node N1 before the gate driver circuit 1220 starts the operation, or when the gate driver circuit 1220 is at rest is equal to the electrical potential VG supplied to the high-side driver 228H. In other words, in the case in which the transistor M1 and the transistor M2 are in the OFF state, no direct current flows since the load to be driven is the capacitive load Z1, and the electrical potential of the first node N1 becomes VG due to a leakage current from the high-side driver 228H.

Here, one end of the bootstrap capacitor C3 is electrically connected to the first node N1. Since the first node N1 is equal to VG before the gate driver circuit 1220 starts the operation, or when the gate driver circuit 1220 is at rest, the inter-terminal voltage of the bootstrap capacitor C3 is kept at roughly zero.

In the explanation using FIG. 6, in the period between the time points 0 and T1, the enable signal 410 for setting the gate driver circuit 1220 to the active state is kept at the low level, and the period between the time points 0 and T1 corresponds to the period before the gate driver circuit 1220 starts the operation. On this occasion, as shown in FIG. 6, the inter-terminal voltage of the bootstrap capacitor C3 is kept at roughly zero. It should be noted that it is assumed that the modulation signal 404, the gate signal GH, and the gate signal GL are also kept in the low level as shown in FIG. 6.

Here, when the enable signal 410 turns to the high level and the operation of the gate driver circuit 1220 starts at the time point T1, the gate signal GL turns to the high level in contrast to the gate signal GH, and the transistor M1 turns to the ON state. Then, a current rapidly flows through the transistor M1, and the electrical potential of the first node N1 turns to GND.

Then, in order to charge the bootstrap capacitor C3, a rapid current flows through a channel from the power supply VG to GND passing through the bootstrap diode D1, the bootstrap capacitor C3, and the transistor M1. The dotted line shown in FIG. 5 indicates the channel of the current described above.

Here, in the capacitive load drive circuit 1200 of the comparative example, a component for limiting the current is not at all disposed, and it is possible that, for example, the current as high as about 10 A flows rapidly. On this occasion, due to the flow of the current higher than the rated value, the bootstrap diode D1 and the transistor M1 might be deteriorated. In other words, in the capacitive load drive circuit 1200 of the comparative example, there is a possibility that an overcurrent flows through these components, and thus, there is a possibility that the reliability of the circuit is reduced.

Here, the capacitive load drive circuit 200 according to the present embodiment will be explained again with reference to FIG. 3. In the capacitive load drive circuit 200 according to the present embodiment, the first resistor R1 is disposed in the supply channel from the power supply VG to the bootstrap circuit, specifically between the power supply VG and the second node N2. For example, assuming that the resistance value of the first resistor R1 is on the order of 10Ω, even in the case of assuming the case in which the current as high as on the order of 10 A flows in the comparative example, the current can be suppressed to on the order of 1 A.

Specifically, the capacitive load drive circuit 200 according to the present embodiment prevents the overcurrent from flowing through the bootstrap diode D1 and the transistor M1 when the gate driver circuit 220 starts the operation. Therefore, it is possible to prevent the deterioration of these components to thereby provide the capacitive load drive circuit 200 high in reliability.

Further, as shown in FIG. 3, the second node N2 is the contact point at which the bootstrap diode D1 and the high-side driver 228H are connected to each other. Therefore, even in the case of disposing the bootstrap diode D1 between the power supply VG and the second node N2, there is no chance to blunt the gate signal GH. Therefore, it becomes easy to design the capacitive load drive circuit 200. Further, in the case in which, for example, the capacitive load drive circuit 1200 of the comparative example assuring dead time described later has already existed, by adding the first resistor R1, the improved design for preventing the overcurrent from flowing through the bootstrap diode D1 and the transistor M1 without affecting the gate signal GH is made possible.

### B. Second Embodiment

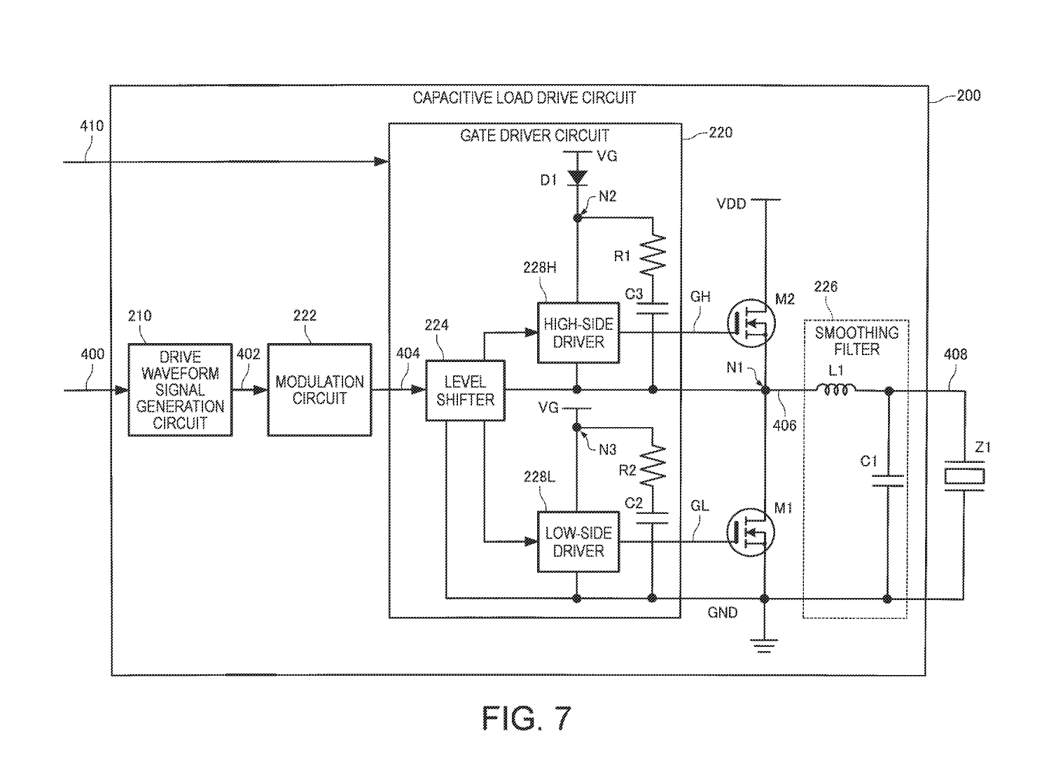

Hereinafter, a second embodiment will be explained. FIG. 7 is an explanatory diagram showing a detailed configuration of the capacitive load drive circuit 200 according to the present embodiment. Unlike the first embodiment, in the capacitive load drive circuit 200 according to the present embodiment, the first resistor R1 is disposed between the second node N2 and the bootstrap capacitor C3. Further, unlike the first embodiment, a second resistor R2 is also disposed on the low-side driver 228L side. It should be noted that regarding other components, the same components as those shown in FIGS. 1 through 6 are denoted with the same reference symbols, and the detailed explanation thereof will be omitted.

On this occasion, the first resistor R1 is disposed in the supply channel from the power supply VG to the bootstrap circuit, and similarly to the first embodiment, it is possible to prevent the overcurrent from flowing through the bootstrap diode D1 and the transistor M1. On the other hand, unlike the first embodiment, the first resistor R1 blunts the waveform of the gate signal GH. However, in the second embodiment, by making use of such a characteristic, the capacitive load drive circuit 200 small in circuit size can be realized while providing the first resistor R1 with both of the function of prevention of the overcurrent and the function of waveform shaping of the gate signal GH. It should be noted that the second resistor R2 is provided for blunting the waveform of the data signal GL. In the present embodiment, the resistance value of the second resistor R2 is the same as that of the first resistor R1 in order to make the waveform coincide between the gate signal GH and the gate signal GL, but can also be different from each other.

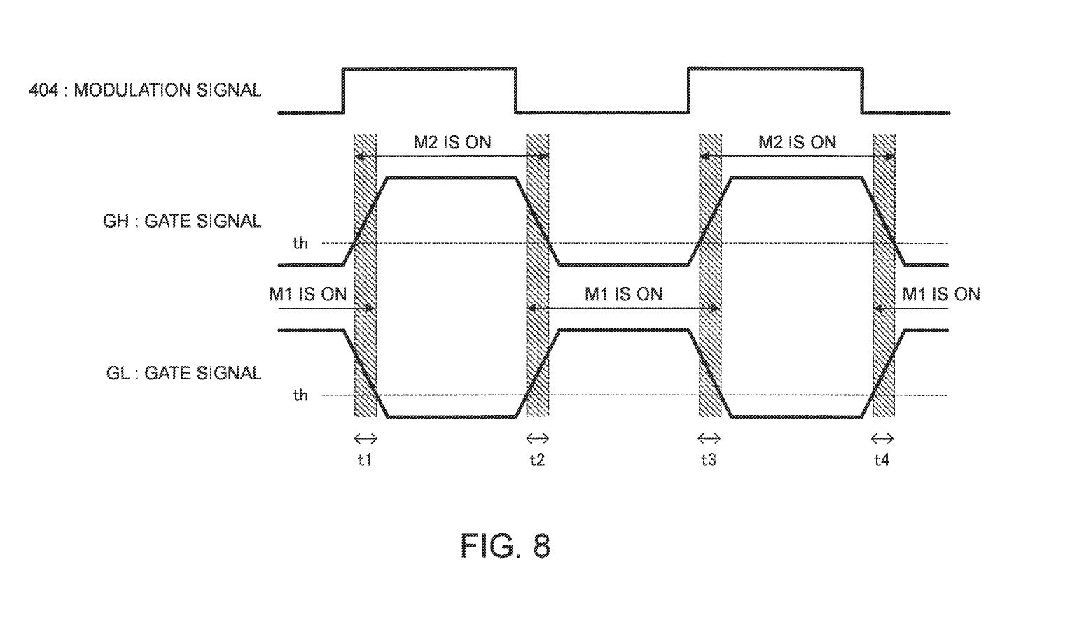

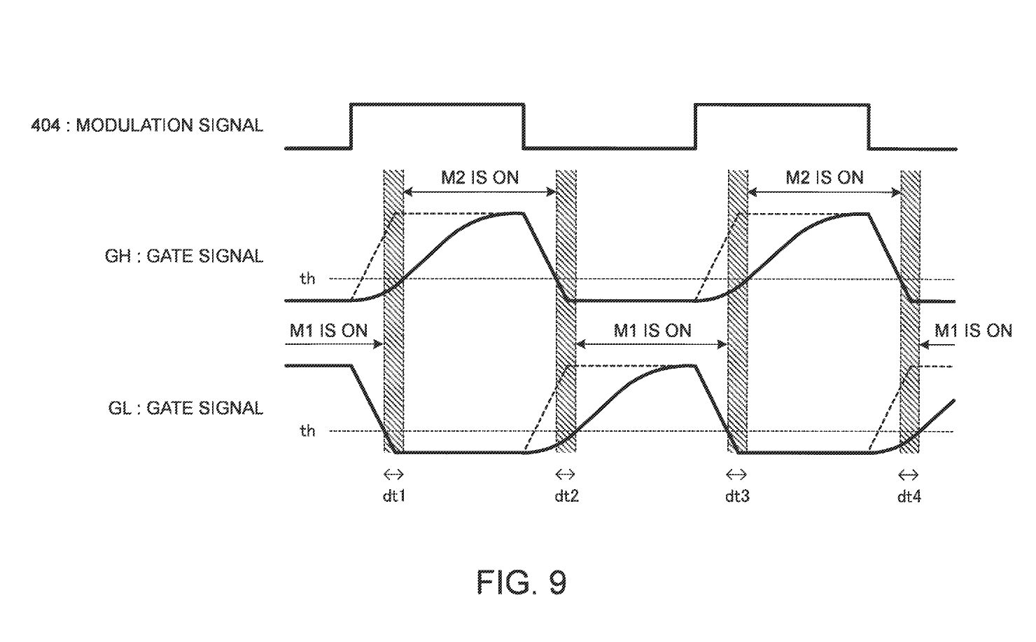

FIGS. 8 and 9 are diagrams showing the timing of the gate signals GH, GL. It should be noted that the same components as those shown in FIGS. 1 through 7 are denoted with the same reference symbols, and the detailed explanation thereof will be omitted. FIG. 8 shows the case in which the gate signals GL. GH to be input to the transistors M1, M2 connected to each other to form a push-pull structure are generated based on the modulation signal 404 so as to be the signals reverse to each other. On this occasion, although the transistors M1, M2 ideally perform the exclusive operation, in reality, since the gate signals GL, GH each have finite rising time and finite falling time, there occurs the period in which the transistors M1, M2 are in the ON state at the same time. In particular, in the case of using the MOSFET as the switching element as in the case of the present embodiment, the saturation voltage higher than the threshold value th of the gate is set in order to reduce the ON resistance to thereby improve the efficiency. Therefore, in the case of charging and discharging the gate signals GH, GL at the same timing, there occur the periods in which the transistors M1, M2 are in the ON state at the same time as indicated by t1 through t4 in FIG. 8, and short circuit occurs between VDD and GND.

FIG. 9 is a diagram showing an example of the improved timing of the gate signals GH. GL, and the short circuit state shown in FIG. 8 can be eliminated. In the example shown in FIG. 9, the rising timing is delayed when charging the transistors M1, M2. In other words, the timing at which the transistors M1, M2 turn ON is delayed compared to the case shown in FIG. 8. On this occasion, as the periods dt1 through dt4 shown in FIG. 9, the dead time, which is the period in which the transistors M1, M2 are in the OFF state at the same time, can be ensured, and thus, there is no chance that the short circuit occurs between VDD and GND. Although the timing at which the transistors M1, M2 turn ON varies due to, for example, the manufacturing tolerance and the temperature dependency, since the dead time exists, the short circuit state can be avoided even if such a variation occurs.

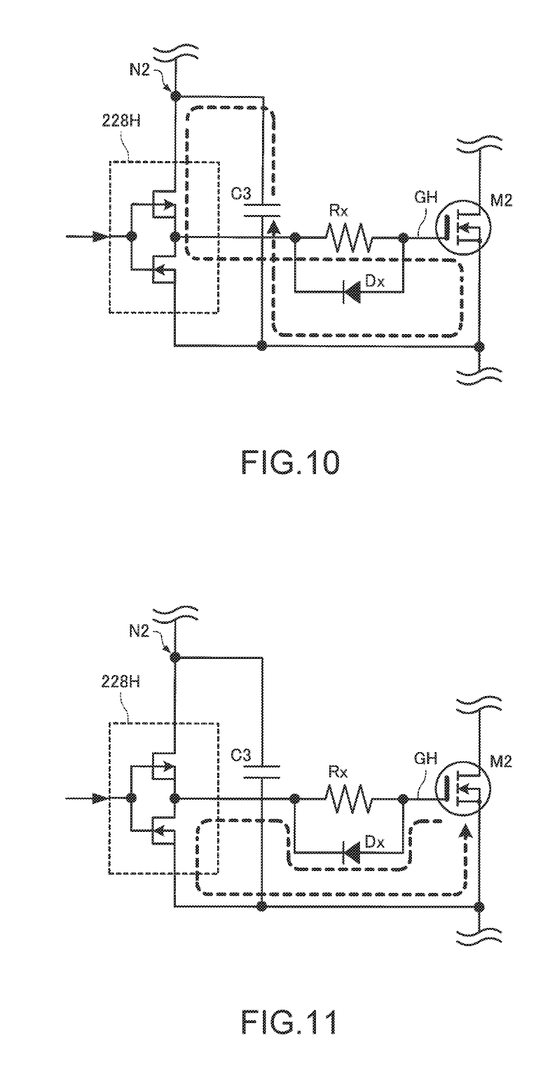

FIGS. 10 and 11 show a configuration example of the circuit using the related art method for realizing the gate signals GH, GL shown in FIG. 9. It should be noted that the same components as those shown in FIGS. 1 through 9 are denoted with the same reference symbols, and the detailed explanation thereof will be omitted. Further, although in FIGS. 10 and 11, and FIGS. 12 and 13, which are referred to later, the high-side driver 228H alone is explained in order to avoid a redundant explanation, the same applies to the low-side driver 228L. Specifically, it is possible to substitute the low-side driver 228L for the high-side driver 228H, the third node N3 for the second node N2, the capacitor C2 for the bootstrap capacitor C3, the gate signal GL for the gate signal GH, the transistor M1 for the transistor M2, and the second resistor R2 for the first resistor R1.

FIG. 10 is a diagram for explaining a channel of a current in charging the gate according to a method of the related art. The channel of the current is indicated by the dotted line shown in FIG. 10 (the same applies to FIGS. 11 through 13 described later). In the related art method, a resistor Rx and a diode Dx are disposed in parallel to each other in the wiring line through which the gate signal GH propagates as shown in FIG. 10. When charging the transistor M2, the rising timing is delayed due to the resistor Rx.

FIG. 11 is a diagram for explaining a channel of a current in discharging the gate according to the related art method. The configuration of the circuit is the same as shown in FIG. 10, and the explanation of the components will be omitted. When discharging the transistor M2, by bypassing the resistor Rx with the diode Dx, the falling timing can be prevented from being delayed. Therefore, the related art method using the resistor Rx and the diode Dx can also ensure the dead time dt1 through dt4 as shown in FIG. 9.

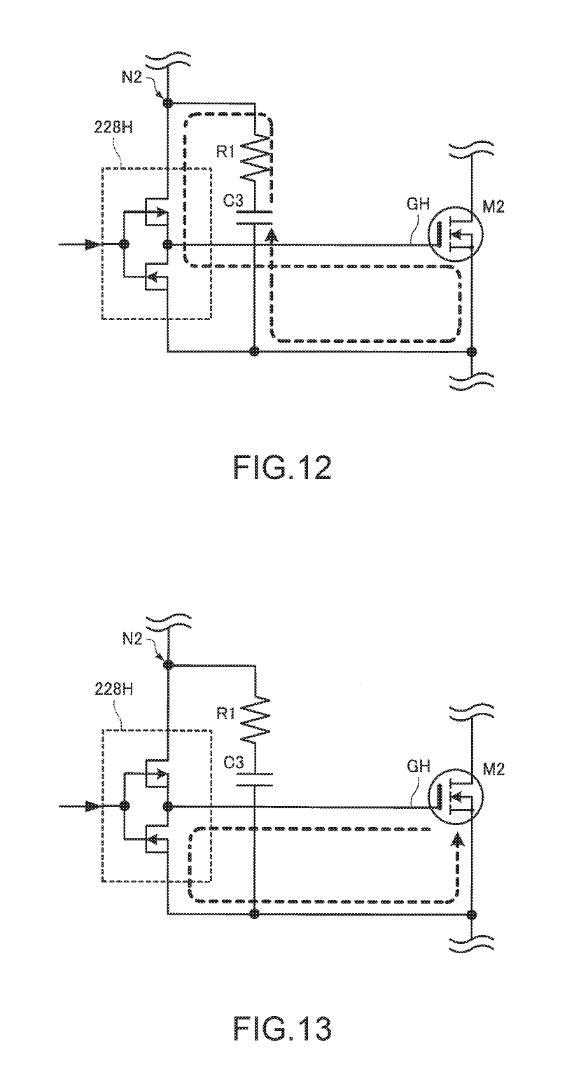

On the other hand, FIGS. 12 through 13 are diagrams for explaining the fact that the capacitive load drive circuit 200 according to the present embodiment can realize the gate signals GH, GL shown in FIG. 9. FIG. 12 is a diagram corresponding to FIG. 10, and for explaining a channel of a current in charging the gate. In the present embodiment, the first resistor R1 is disposed in series to the bootstrap capacitor C3. Therefore, as shown in FIG. 12, when performing the charge, since the gate of the transistor M2 is driven by the bootstrap capacitor C3 via the first resistor R1, the rising timing is delayed.

FIG. 13 is a diagram corresponding to FIG. 11, and for explaining a channel of a current in discharging the gate. As shown in FIG. 13, when discharging the transistor M2, since the bootstrap capacitor C3 and the first resistor R1 are eliminated from the channel, the falling timing can be prevented from being delayed.

As shown in FIGS. 12 through 13, the dead time dt1 through dt4 can also be ensured as shown in FIG. 9 by the capacitive load drive circuit 200 according to the present embodiment. On this occasion, since the diode Dx is unnecessary, the circuit size can be reduced compared to the related art method. In other words, the capacitive load drive circuit 200 according to the present embodiment can not only prevent the overcurrent from flowing through the bootstrap diode D1 and the transistor M1 similarly to the first embodiment, but also realize the capacitive load drive circuit 200 small in circuit size compared to the related art method.

Further, although the circuit using the smoothing filter 226 is explained as the capacitive load drive circuit 200 according to the present embodiment, the smoothing filter 226 is not an essential component due to the resistive component of the wiring line and the capacitive component of the capacitive load Z1.

### C. Application Example

In the embodiment described above, the explanation is presented assuming that the capacitive load drive circuit 200 is installed in the inkjet printer 10. However, the capacitive load drive circuit 200 can be installed in a variety of devices besides the inkjet printer 10 to thereby enhance the reliability of the devices.

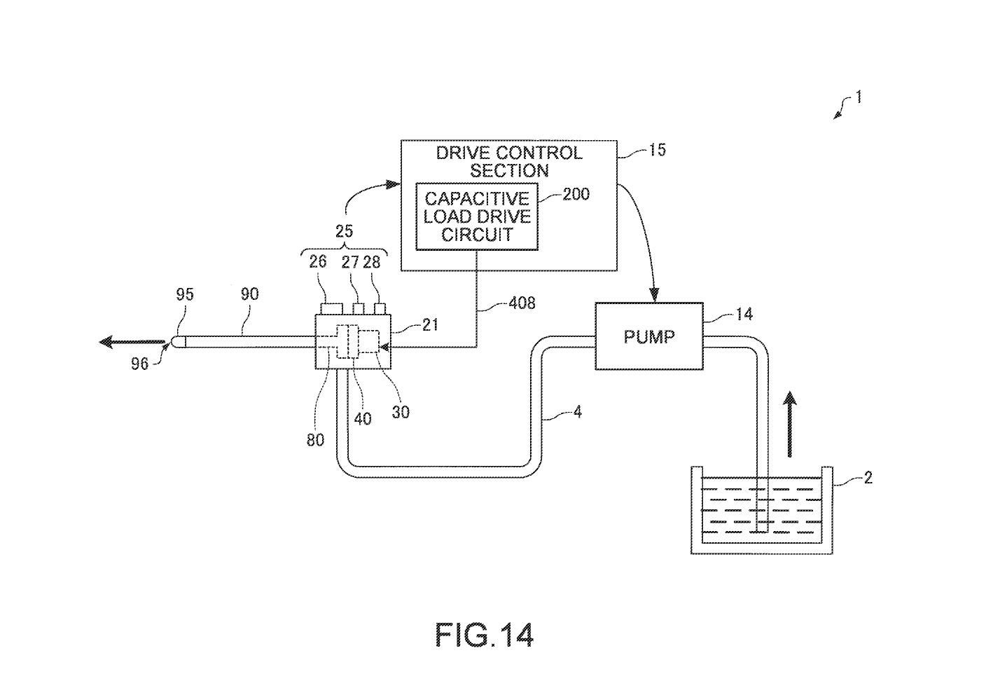

For example, the capacitive load drive circuit 200 can be applied to a fluid ejection device 1. FIG. 14 is an explanatory diagram exemplifying the fluid ejection device 1 as an application example. Although the fluid ejection device 1 can be adopted to a variety of applications such as cleansing of a minute object and structure, and a surgical knife, the explanation will be presented here assuming that the fluid ejection device 1 is suitable for incising or excising body tissue. Therefore, the fluid used here is a liquid such as water or saline.

In FIG. 14, the fluid ejection device 1 is provided with a fluid supply container 2 holding a fluid, a pump 14 as a fluid supply device, a pulsating flow generation section 21 for converting the fluid supplied from the pump 14 into a pulsating flow (hereinafter also referred to as a pulse flow), and a drive control section 15 for controlling the drive of the pump 14 and the pulsating flow generation section 21. The pump 14 and the pulsating flow generation section 21 are connected to each other with a fluid supply tube 4.

A connection channel tube 90 with a thin pipe-like shape is connected to the pulsating flow generation section 21, and a nozzle 95 having a fluid ejection opening section 96 with a reduced channel diameter is inserted in a tip portion of the connection channel tube 90. It should be noted that the connection channel tube 90 has rigidity on the order of not being deformed in ejecting the fluid.

Further, the pulsating flow generation section 21 is provided with a pulse flow command switch 26 having an ejection command switching device 25, and for selecting pulse flow ejection as an ejection command switching device in the present application example, a continuous flow command switch 27 for selecting continuous flow ejection, and an OFF switch 28 for stopping the fluid ejection.

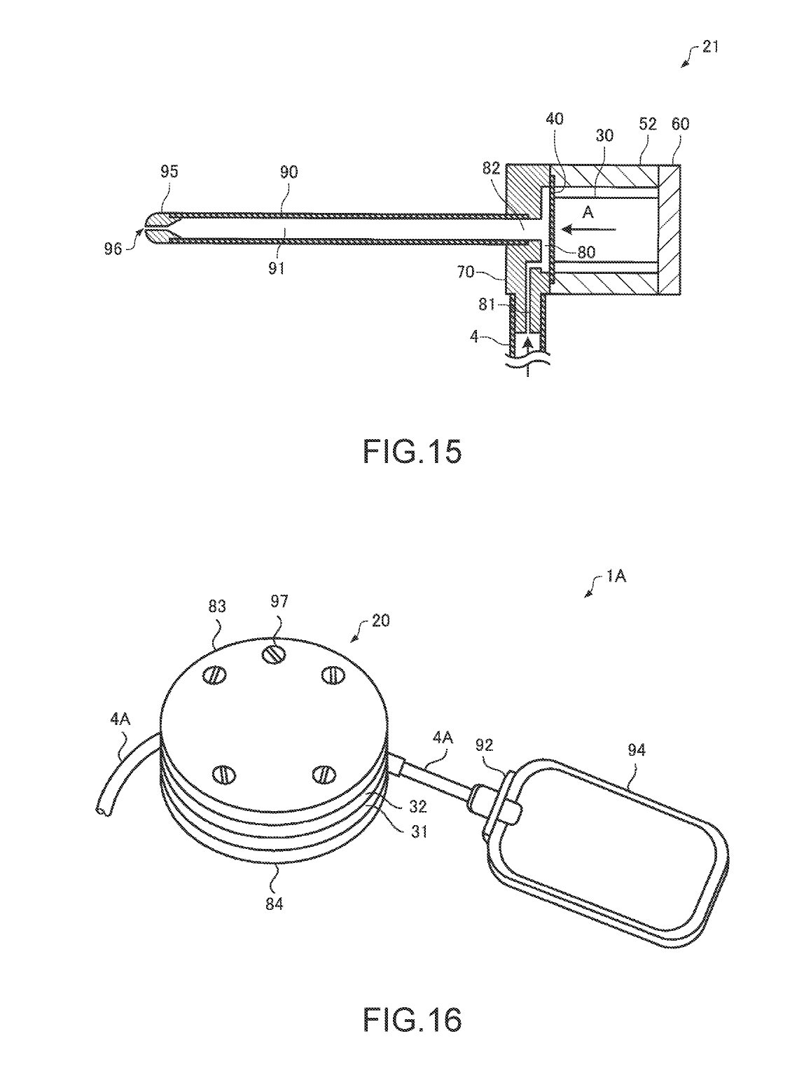

Flowage of the fluid in the fluid ejection device 1 configured in such a manner as described above will briefly be explained. The fluid contained in the fluid supply container 2 is suctioned by the pump 14, and is then supplied to the pulsating flow generation section 21 through the fluid supply tube 4 at a constant pressure. The pulsating flow generation section 21 is provided with a fluid chamber 80 (see FIG. 15), and a piezoelectric element 30 and a diaphragm 40 as a volume changing device for changing the volume of the fluid chamber 80, and drives the piezoelectric element 30 to generate the pulsating flow in the fluid chamber 80, and thus ejects the fluid at high speed in, for example, a pulsed manner from the fluid ejection opening section 96 through the connection channel tube 90 and the nozzle 95.

It should be noted that in the case in which the pulsating flow generation section 21 stops driving, the fluid supplied from the pump 14 passes through the fluid chamber 80, and is ejected from the fluid ejection opening section 96 as a continuous flow.

Here, the pulsating flow denotes the flowage of the fluid having a constant flow direction of the fluid, and the flow rate or the flow speed of the fluid including a periodical or irregular variation. Although the pulsating flow includes intermittent flow of repeating flow and stop of the fluid, since it is sufficient that the flow rate or the flow speed of the fluid varies periodically or irregularly, the intermittent flow is not necessarily required.

Similarly, “ejecting the fluid in a pulsed manner” denotes the ejection of the fluid having the flow rate or moving speed of the fluid varying periodically or irregularly. Although the intermittent ejection of repeating ejection and non-ejection of the fluid can be cited as an example of the ejection in a pulsed manner, since it is sufficient that the flow rate or the moving speed of the fluid to be ejected varies periodically or irregularly, the intermittent ejection is not necessarily required.

FIG. 15 is a cross-sectional view showing a cutting surface of a pulsating flow generation section 21 according to the present application example cut along the ejection direction of the fluid. It should be noted that FIG. 15 is a schematic diagram having contraction scales in the vertical and horizontal directions of the members or parts different from the actual scales for the sake of convenience of graphical description. The pulsating flow generation section 21 is configured including an entrance channel 81 for supplying the fluid to the fluid chamber 80 from the pump 14 via the fluid supply tube 4, the piezoelectric element 30 and the diaphragm 40 as the volume changing section for changing the volume of the fluid chamber 80, and an exit channel 82 communicating with the fluid chamber 80. The entrance channel 81 is attached with the fluid supply tube 4.

The diaphragm 40 is formed of, for example, a disk-like thin metal plate, and is made to adhere by a case 52 and a case 70. The piezoelectric element 30 is exemplified by a laminated piezoelectric element in the present embodiment, and is fixed to the diaphragm 40 in one of the both end portions, and is fixed to a bottom plate 60 in the other thereof.

The fluid chamber 80 is a space formed of a recessed section and the diaphragm 40, wherein the recessed section is provided to the surface of the case 70, opposed to the diaphragm 40. At a roughly central section of the fluid chamber 80, there is opened an exit channel 82.

The case 70 and the case 52 are integrated by being bonded to each other on the respective surfaces opposed to each other. The connection channel tube 90 having a connection channel 91 communicating with the exit channel 82 is fit to the case 70, and the nozzle 95 is inserted into the tip portion of the connection channel tube 90. Further, the fluid ejection opening section 96 with a reduced channel diameter is opened in the nozzle 95.

The piezoelectric element 30 corresponds to the piezoelectric element 104 shown in FIG. 2, and is controlled by the drive signal 408 (see FIG. 14) from the capacitive load drive circuit 200 in deformation amount and deformation timing. Further, by the piezoelectric element 30 pushing the fluid chamber 80 as indicated by the arrow A in FIG. 15, the fluid can be ejected from the nozzle 95 on the tip in a pulsed manner. The fluid ejection device 1 can be used as, for example, a medical instrument. Specifically, the fluid ejection device 1 can be used as surgical equipment, which supplies a liquid at a high pressure from the pump 14 to the fluid supply tube 4 introduced in the body cavity, and ejects the liquid from the nozzle 95 on the tip to perform excision of intracavitary tissue using the fluid pressure.

Further, the capacitive load drive circuit 200 can be applied to a fluid transportation device 20 for transporting a liquid at a stable flow rate.

FIG. 16 is a perspective view showing an appearance of fluid transportation equipment 1A including the fluid transportation device 20 according to the present application example. In FIG. 16, the fluid transportation equipment 1A includes the fluid transportation device 20 for transporting a fluid using a peristaltic motion, and a fluid container 94 shaped like a pack and for containing the fluid. Further, the fluid transportation device 20 and the fluid container 94 communicate with each other via a tube 4A.

The fluid container 94 is made of synthetic resin having flexibility, and is formed of, for example, silicone resin. A tube holding section 92 is disposed in one end portion of the fluid container 94, to which the tube 4A is airtightly fixed using a process such as pressure bonding, thermal fusion, or adhesive bonding so that the fluid is not leaked.

One end portion of the tube 4A communicates with the inside of the fluid container 94. The tube 4A extends to the outside of the fluid transportation device 20 passing through the inside of the fluid transportation device 20. The fluid contained in the fluid container 94 is transported to the outside by the fluid transportation device 20.

The fluid transportation device 20 is formed by sequentially stacking a lower lid 84, a pump unit frame 31, a tube frame 32, and an upper lid 83 one another, and then integrating these components with fixing screws 97 (upper lid fixing screws are shown in the drawing) and so on. An extrusion mechanism for transporting the fluid is incorporated in the fluid transportation device 20.

It should be noted that in the case of mounting the fluid transportation equipment 1A to a living body, it is preferable to adopt a material superior in biocompatibility, for example, synthetic resin such as polysulfone or urethane for the lower lid 84, the pump unit frame 31, the tube frame 32, the upper lid 83, and the fluid container 94.

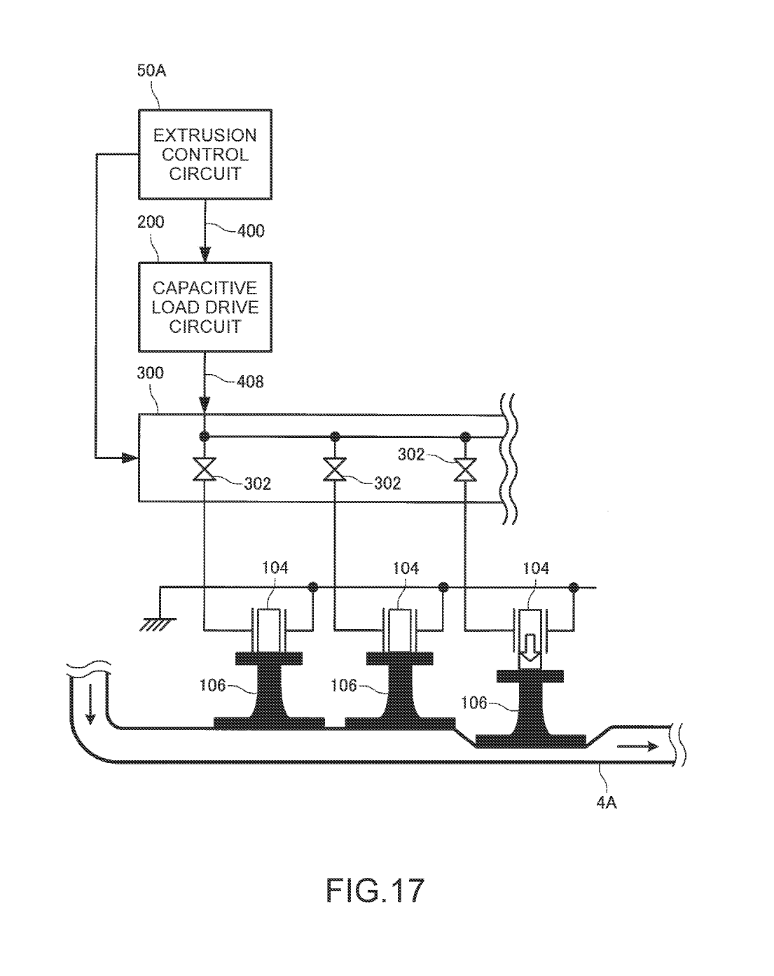

FIG. 17 is a diagram for explaining a mechanism of the fluid transportation of the fluid transportation device 20. The drive signal 408, which is the voltage to be applied to the piezoelectric element 104, is generated by the capacitive load drive circuit 200 based on the control signal 400 from an extrusion control circuit 50A (not shown in FIG. 16). Further, the drive signal 408 thus generated is supplied to the piezoelectric element 104 via the gate unit 300. The gate unit 300 is a circuit unit having a plurality of gate elements 302 connected in parallel to each other, and each of the gate elements 302 can individually be set to one of a conduction state and a disconnection state under the control by the extrusion control circuit 50A. Therefore, the drive signal 408 output from the capacitive load drive circuit 200 is made to sequentially pass through the gate elements 302 by the extrusion control circuit 50A, and is then applied to the corresponding piezoelectric elements 104 to thereby extrude corresponding pressing shafts 106. The pressing shafts 106 are arranged in parallel to the direction in which the fluid in the tube 4A flows. Further, the tube 4A is pressed in sequence by the plurality of pressing shafts 106. Therefore, the fluid transportation device 20 can transport the fluid in the tube 4A using the peristaltic motion.

It should be noted that as the fluid used in the invention, in addition to liquids with fluidity such as water, a saline solution, a medicinal solution, oils, an aromatic solution, and ink, gases can also be used. In the case of using, for example, a medical solution, the fluid transportation device 20 can be used as a medication pump, and can be applied to a variety of types of medical instruments.

### D. Others

The invention includes configurations (e.g., configurations having the same function, the same way, and the same result, or configurations having the same object and the same advantage) substantially the same as the configuration explained as the embodiments and the application examples described above. Further, the invention includes configurations obtained by replacing a non-essential part of the configurations explained in the embodiment section and so on. Further, the invention includes configurations providing the same functions and the same advantages or configurations capable of achieving the same object as that of the configurations explained in the embodiment section and so on. Further, the invention includes configurations obtained by adding technologies known to the public to the configurations explained in the embodiment section and so on.

This application claims priority to Japanese Patent Application No. 2012-193274 filed on Sep. 3, 2012 the entirety of which is hereby incorporated by reference.

What is claimed is:

1. A capacitive load drive circuit adapted to apply a drive signal to a capacitive load, comprising:
a modulation circuit adapted to pulse-modulate a drive waveform signal to thereby generate a modulation signal;
two switching elements constituting a push-pull circuit, and adapted to generate a power-amplified modulation signal, which is a signal obtained by power-amplifying the modulation signal;
a first gate driver adapted to switch ON/OFF of a first switching element, which is one of the two switching elements, and is disposed on a ground potential side, based on the modulation signal;
a second gate driver adapted to switch ON/OFF of a second switching element, which is the other of the two switching elements, based on the modulation signal;
a bootstrap circuit having a first capacitor electrically connected to a first node, which is a contact point to which the two switching elements are connected;
a power supply adapted to supply the first gate driver and the second gate driver with an electrical potential; and
a first resistor disposed in a supply channel from the power supply to the bootstrap circuit.

2. The capacitive load drive circuit according to claim 1, wherein
the bootstrap circuit includes a diode electrically connected to the first capacitor, and
the first resistor is disposed between a second node, which is a contact point to which the diode and the second gate driver are connected, and the power supply.

3. The capacitive load drive circuit according to claim 1, wherein
the bootstrap circuit includes a diode electrically connected to the power supply, and
the first resistor is disposed between a second node, which is a contact point to which the diode and the second gate driver are connected, and the first capacitor.

4. The capacitive load drive circuit according to claim 3, further comprising:
a second capacitor disposed between a third node, which is a contact point to which the power supply and the first gate driver are connected, and the ground potential; and
a second resistor disposed between the third node and the second capacitor.

5. The capacitive load drive circuit according to claim 4, wherein
a resistance value of the first resistor and a resistance value of the second resistor are equal to each other.

6. A medical instrument comprising:
the capacitive load drive circuit according to claim 1.

7. A medical instrument comprising:
the capacitive load drive circuit according to claim 2.

8. A medical instrument comprising:
the capacitive load drive circuit according to claim 3.

9. A medical instrument comprising:
the capacitive load drive circuit according to claim 4.

10. A medical instrument comprising:
the capacitive load drive circuit according to claim 5.
